(19) United States
(12) Patent Application Publication
(10) Pub. No.: US 2025/0298376 A1
(43) Pub. Date: Sep. 25, 2025

(54) DECORATIVE PLATE AND TIMEPIECE

(71) Applicant: CASIO COMPUTER CO., LTD., Tokyo (JP)

(72) Inventor: Seiji SYOUBAYASHI, Tokyo (JP)

(73) Assignee: CASIO COMPUTER CO., LTD., Tokyo (JP)

(21) Appl. No.: 19/072,691

(22) Filed: Mar. 6, 2025

(30) Foreign Application Priority Data
Mar. 19, 2024 (JP) 2024-043303

(51) Int. Cl. G04B 19/06; G04C 10/02

(52) U.S. Cl. CPC G04B 19/06; G04C 10/02

(57) ABSTRACT

A decorative plate is placed on one surface side of a solar cell. The decorative plate includes a plurality of first inclined surface and a through hole. The plurality of first inclined surfaces are formed from one side to an other side. The first inclined surfaces rise from the solar cell side. The first inclined surfaces rise from the one side to the other side. The through hole is formed in at least a part between adjacent first inclined surfaces. A region of the decorative plate located on the one side of the through hole and a region of the decorative plate located on the other side of the through hole are provided in positions that do not overlap in plan view.

### CROSS-REFERENCE TO RELATED APPLICATIONS

This application is based upon and claims the benefit of priority from the prior Japanese Patent Application No. 2024-043303, filed on Mar. 19, 2024, the entire contents of which are incorporated herein by reference.

### BACKGROUND OF THE INVENTION

### Field of the Invention

The present invention relates to a decorative plate and a timepiece.

### Description of the Related Art

JP2015-184256 describes a watch display plate having a substrate and a plurality of decorative elements arranged on the substrate and inclined at a predetermined angle with respect to the substrate surface. Light reflected off the surface of the decorative elements inclined at a predetermined angle with respect to the substrate surface is incident on a light receiving surface of a solar cell.

### SUMMARY

In order to solve the aforementioned problem, a decorative plate according to the present invention is a decorative plate placed on one surface side of a solar cell, the decorative plate including:
a plurality of first inclined surfaces formed from one side to an other side, wherein, the first inclined surfaces rise from the solar cell side, and the first inclined surfaces rise from the one side to the other side; and
a through hole formed in at least a part between adjacent first inclined surfaces,
wherein a region of the decorative plate located on the one side of the through hole and a region of the decorative plate located on the other side of the through hole are provided in positions that do not overlap in plan view.

### BRIEF DESCRIPTION OF THE DRAWING

FIG. 1 is a front view of a timepiece according to the present embodiment;

FIG. 2 is a diagram of a dial provided on the timepiece shown in FIG. 1;

FIG. 3 is a cross-sectional view along line III-III in FIG. 1; and

FIG. 4 is an enlarged cross-sectional view of a IV portion circled by a dashed line in FIG. 3.

### DETAILED DESCRIPTION OF THE PREFERRED EMBODIMENTS

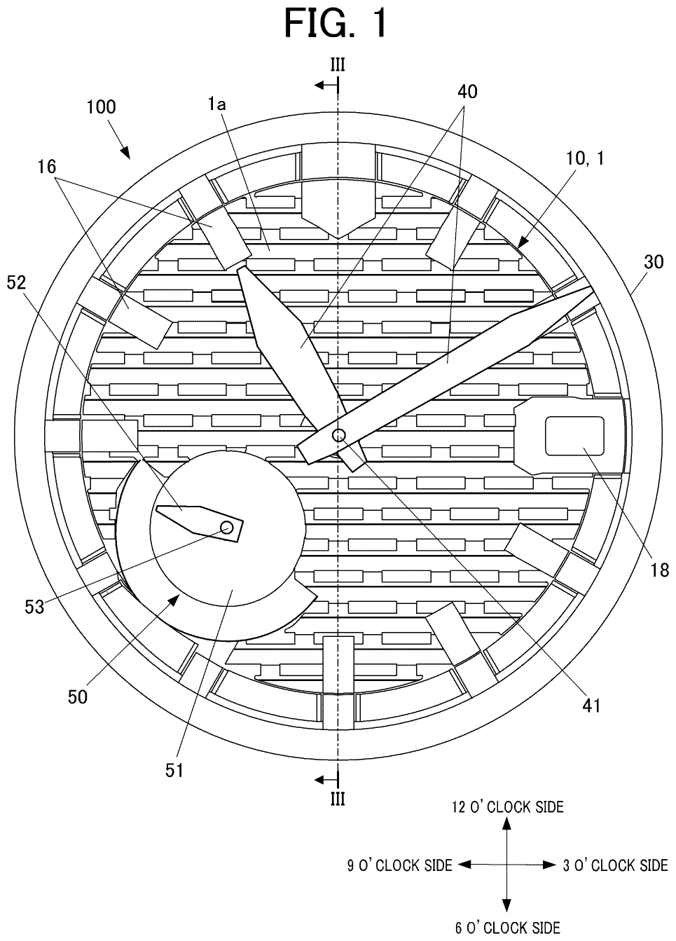

With reference to the drawings, one embodiment of a decorative plate and a timepiece of the present invention will be described. The present embodiment shows a case in which the decorative plate is a dial of a timepiece. In addition, the case in which the timepiece is a wristwatch to be worn on an arm is assumed in the present embodiment. In FIG. 1, etc., a band for wearing the timepiece on the arm and internal components of the timepiece are not illustrated. In the present embodiment, the case in which a timepiece 100 is approximately circular in plan view is illustrated (see FIG. 1, etc.), but the shape of the timepiece 100 is not limited to this and may be rectangular or oval in plan view, for example. Various limitations that are technically preferable to implement the present disclosure are added to the embodiments described below. However, the scope of the present disclosure is not limited to the embodiments and the illustrated examples described below.

The timepiece 100 according to the present embodiment includes at least a dial 10 (decorative plate) and a solar cell 70. As shown in FIG. 1, when the timepiece 100 is viewed from a surface side (viewing side), an opening part on a surface side of the case, which is not shown in the drawing, is provided with an annular dial cover 30 along an outer rim. The dial 10 is located on an inner side of the dial cover 30. The timepiece 100 according to the present embodiment includes a plurality of hands 40 that are attached to a pointer shaft 41 provided almost in the center of the dial 10, and the time is displayed on the timepiece 100 in an analog manner. In other words, the dial 10 is provided with hour markers 16 along its periphery, and the hands 40 point to the hour markers 16 to indicate the time as appropriate. FIG. 1 illustrates a case in which the timepiece 100 includes two hands 40 (e.g., hour hand and minute hand). The number and shape of the hand 40 are not limited to the illustrated examples.

In the illustrated example, a portion to function as the hour marker is also provided in a position that is on the top surface of the dial cover 30, and that corresponds to the hour marker 16 provided on the dial 10. The configuration of the corresponding portions of the hour markers 16 and the dial cover 30 on the dial 10 is not particularly limited. For example, the hour marker 16 and corresponding portions may be three-dimensionally formed or flatly provided by printing or various surface treatments. The hour marker 16 need only be located at a position that is on an outer circumference of the timepiece 100 and that can be pointed to by the hands 40. It is not necessary to provide the hour marker 16 on the dial 10. For example, the hour markers 16 may be provided on only either one of the dial 10 or the dial cover 30.

The timepiece 100 illustrated in FIG. 1 is provided with a sub-display 50 between 7 o'clock and 8 o'clock positions. A small display plate 51 that is approximately circular in shape is positioned in the sub-display 50. A shaft 53 is provided approximately at the center of the small display plate 51, and the sub-display 50 includes a small hand 52 that is attached to the shaft 53 and rotates around the shaft. The small hand 52 is, for example, a functional hand that has a world time function to display the hour and minute of a specified region of the world (local time) and a function to display various information such as temperature and humidity. In addition, at approximately the 3 o'clock position in the timepiece 100, there is a date window 18 that allows selective exposure of the date on a day wheel, which is not shown. It is not required that the timepiece 100 have the sub-display 50 or the date window 18. The placement, shape, and configuration of the sub-display 50 and date window 18 are not limited to the illustrated example.

JP2015-184256 describes a watch display plate having a substrate and a plurality of decorative elements arranged on the substrate and inclined at a predetermined angle with respect to the substrate surface. Light reflected off the surface of the decorative elements inclined at a predetermined angle with respect to the substrate surface is incident on a light receiving surface of a solar cell.

However, with the configuration in JP2015-184256, only light reflected from the surface of the decorative body inclined at a predetermined angle to the substrate surface can be captured by the light receiving surface of the solar cell, making it difficult to obtain sufficient power by the solar cell.

The purpose of the present invention is to improve and solve the problems of such a situation, and to provide a decorative plate and a timepiece that can improve efficiency of light incidence to the solar cell with a highly designable configuration.

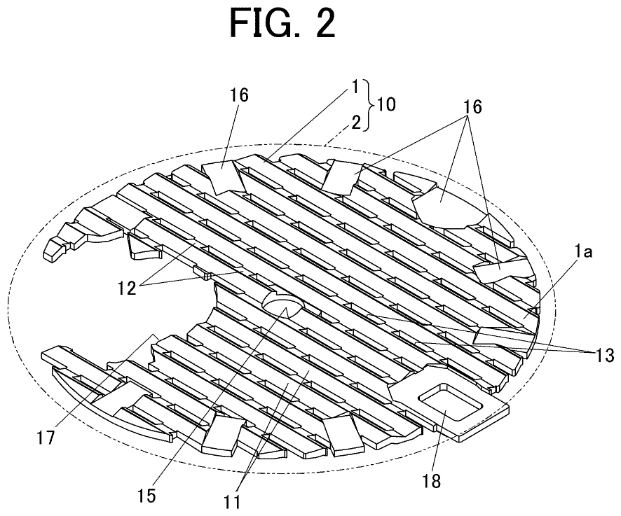

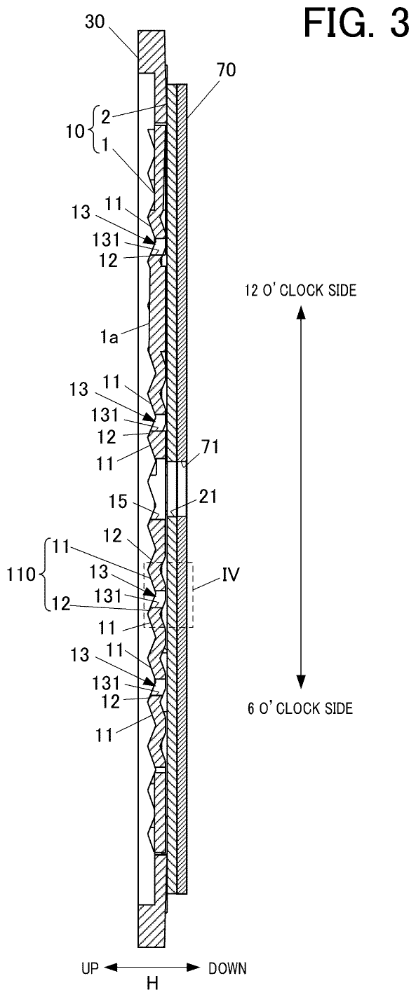

As shown in FIG. 3, the dial 10 is located on one side of the solar cell 70, described below. As shown in FIG. 2 and FIG. 3, the dial 10 in this embodiment has an upper dial 1, which constitutes an outer appearance of the timepiece 100, and a lower dial 2, which is located on a rear side (lower, non-visible side) of the upper dial 1. The upper dial 1 and the lower dial 2 are made of various resin materials, such as polycarbonate resin, for example. In FIG. 2, the lower dial 2 is shown as a double-dashed line. The materials used to form the upper dial 1 and lower dial 2 are not limited to those illustrated here. The upper dial 1 and lower dial 2 may be made of different materials. In FIG. 2, the illustration of the hand 40 and pointer shaft 41 are omitted.

The upper dial 1 is a plate-like member that is approximately circular in shape overall. In this embodiment, a metal vapor deposition film is formed on a surface 1a of the dial 10 (in the present embodiment, the upper dial 1). As metal vapor deposition films, an aluminum vapor deposition film in which aluminum is used for vapor disposition and a titanium vapor deposition film in which titanium is used for vapor deposition are assumed. The metal vapor deposition film is not limited to this. The method of metal deposition is not limited, and various techniques can be used. The same metal vapor deposition film may be formed on the entire surface, or the thickness of the vapor deposition film and the type of metal to be deposited by vapor deposition may vary depending on the location and other factors.

In this embodiment, the surface 1a of the upper dial 1 has a plurality of repeating three-dimensional patterns on the portions of the surface 1a other than the portion where the hour marker 16 is located, the portion where the small display plate 51 in the sub-display 50 is located, and the portion where the date window 18 is located. Details of the three-dimensional pattern provided on the surface 1a of the upper dial 1 are described below. The portion of the upper dial 1 where the small display panel 51 is placed has a cutout part 17 cut out in an approximately circular shape to match the shape of the small display plate 51. An opening is also provided in the area where the date window 18 is located to expose the date on the day wheel. A through hole 15 is formed in the approximate center of the upper dial 1, through which the pointer shaft 41 is inserted from the inside.

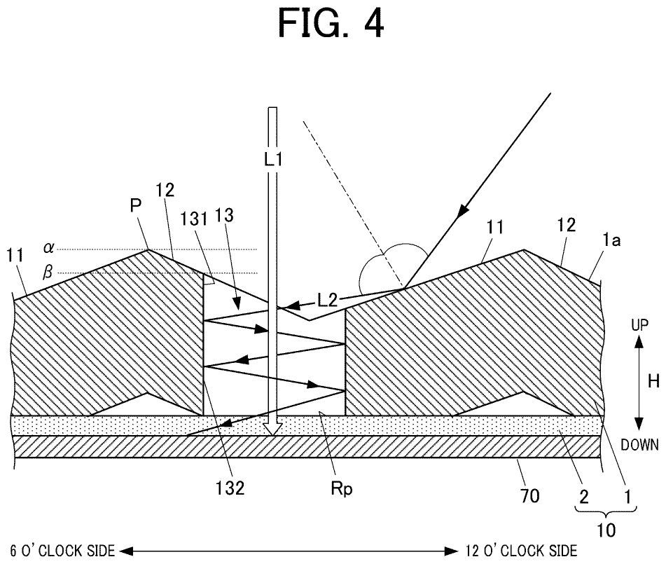

As shown in FIG. 2 and FIG. 3, the lower dial 2 is an approximately circular plate-shaped member formed one size larger than the outer shape of the upper dial 1. The lower dial 2 is placed over the rear side of the upper dial 1. According to the present embodiment, the surface of the lower dial 2, i.e., the surface that is in contact with the rear surface of the upper dial 1, is a reference plane Rp of the dial 10 (see FIG. 4). The lower dial 2 is a light-transmissive dial that is formed of a transparent resin material or the like and that allows light to pass through. A through hole 21 is formed at approximately the center of the lower dial 2, in a position corresponding to the through hole 15 of the upper dial 1. The lower dial 2 is preferably processed to have a lower light transmittance than the other parts in a position where the lower dial 2 does not overlap with the upper dial 1. The type of processing is chosen as appropriate, for example, being darker in color than other areas or printing various types of surfaces. The position that does not overlap with the upper dial 1 is, for example, the portion corresponding to the cutout part 17 formed in the upper dial 1.

Furthermore, as shown in FIG. 3, a solar cell 70 is located on the rear side of the dial 10, which is composed of the upper dial 1 and the lower dial 2. In this embodiment, the solar cell 70 is located on the rear side of the lower dial 2, which is on the lower side (rear side, non-visible side) of the dial 10. The solar cell 70 is, for example, a circular plate-shaped member with the same size and shape as the lower dial 2. A through hole 71 is formed at approximately the center of the solar cell 70, in a position corresponding to the through hole 15 of the upper dial 1 and the through hole 21 of the lower dial 2. The specific shape and configuration of the solar cell is not limited.

The solar cell 70 receives light and generates electricity, and is positioned with the light receiving surface facing the upper side of the timepiece 100 in the thickness direction H. The power generated by the solar cell 70 is used as power for the timepiece 100. However, the solar cell 70 is a black or other material, and if the color of the solar cell 70 is visible from the outside, the outer appearance of the timepiece 100 will be spoiled. Therefore, the solar cell 70 should be hidden by the dial 10 which is positioned above the solar cell 70 in a thickness direction H, so that the solar cell 70 is not easily visible from the outside. The configuration to make the solar cell 70 less visible from the outside is described below.

Next, with reference to FIG. 4, the configuration of the dial 10 (especially the upper dial 1) and its arrangement relationship with the solar cell 70 according to the present embodiment will be explained. In FIG. 4, the relationship of the arrangement of the upper dial 1, lower dial 2, and solar cell 70 in the thickness direction H is accurately shown, but the thickness and shape of each component is schematically shown. For example, in FIG. 4, in order to clarify the configuration of the upper dial 1, a IV portion enclosed by dashed lines in FIG. 3 shows the upper dial 1 in a particularly large size, while the lower dial 2 and solar cell 70 are shown with a thinner thickness compared to the upper dial 1.

The dial 10 is provided with a first inclined surface 11 that goes up from one side to the other side from the solar cell 70 (light receiving surface of the solar cell 70) side. One side is a thumb side when the timepiece 100 is worn on the arm, which is the 6 o'clock side of the timepiece 100 shown in FIG. 1. The other side is a little finger side when the timepiece 100 is worn on the arm, and is the 12 o'clock side of the timepiece 100 shown in FIG. 1. A plurality of the first inclined surfaces 11 are formed from one side to the other side. According to the present embodiment, the solar cell 70 side is the reference plane Rp side of the dial 10 shown in FIG. 4. As shown in FIG. 4, etc., in the dial 10 of the present embodiment, a valley shaped part 110 (see FIG. 3) is formed on the surface 1a of the upper dial 1 to be a valley shape in a cross-sectional view. The valley shaped part 110 includes the first inclined surface 11, which is inclined upward from “one side” (6 o'clock side) to “the other side” (12 o'clock side) from the solar cell 70 side, and a second inclined surface 12 which is inclined downward from “one side” (6 o'clock side) to “the other side” (12 o'clock side) to the solar cell 70 side. The valley shaped part 110 is formed in a substantial V-shape in the cross-sectional view, for example. The valley shaped part 110 is not limited to the substantial V shape in the cross-sectional view, but may be, for example, a substantial inverted trapezoidal shape in the cross-sectional view with a flat portion between the point where the second inclined surface 12 descends completely and the point where the first inclined surface 11 begins to ascend. In this embodiment, as shown in FIG. 2 and FIG. 3, a plurality of valley shaped parts 110 are provided in succession.

A light transparent part 13, which is a through hole, is formed at least partially between the adjacent first inclined surfaces 11. In the embodiment shown in FIG. 4, etc., the dial 10 (in this embodiment, the upper dial 1) includes the light transparent part 13 opening into a region that includes at least a portion of the second inclined surface 12 which is located between the adjacent first inclined surfaces 11. The region of the dial 10 located on “one side” of the light transparent part 13 and the region of the dial 10 located on the “other side” of the light transparent part 13 are not overlapped in plan view. In other words, the 6 o'clock side region and the 12 o'clock side region of the light transparent part 13 do not overlap each other. Therefore, the light transparent part 13 which is the through hole is open upward and can take in light L1 from above.

In FIG. 3 and FIG. 4, the portion of the light transparent part 13 that is open is designated as the opening portion 131. In this embodiment, an opening ratio of the opening portion 131 of the light transparent part 13 is about 17 to 20% of the total area in the dial 10 (in this embodiment, the upper dial 1). The light transparent part 13 allows light from above to pass through and enter the solar cell 70 located on the rear side. As shown in FIG. 4, in this embodiment, light passing through the light transparent part 13 includes light L1 (indicated by a white arrow in FIG. 4) that enters the solar cell 70 directly from the upper direction and reflected light L2 (indicated by an arrow in FIG. 4) that enters the light transparent part 13 from an oblique direction and is reflected within the light transparent part 13 to enter the solar cell 70.

That is, the light transparent part 13 includes a vertical wall 132 formed from the opening portion 131 formed in the second inclined surface 12 toward the solar cell 70 side. As shown by the arrow in FIG. 4, this vertical wall 132 reflects at least the reflected light L2 reflected on the first inclined surface 11 toward the solar cell 70 side. In particular, according to the present embodiment, as mentioned above, a metal vapor deposition film such as aluminum is formed on the surface 1a of the dial 10 (in this embodiment, the upper dial 1). According to the present embodiment, as shown in FIG. 4, etc., the vertical wall 132 of the light transparent part 13 is provided to be approximately orthogonal to the solar cell 70. This facilitates the formation of the metal vapor deposition film on the first inclined surface 11 and second inclined surface 12, as well as on the vertical wall 132 of the light transparent part 13. Therefore, the light entering the first inclined surface 11 is efficiently reflected, and the reflected light L2 enters the light transparent part 13. As shown by the arrow in FIG. 4, the light repeatedly reflects at the vertical wall 132 and enters the solar cell 70 from the reference plane Rp side of the dial.

According to the present embodiment, the opening portion 131 is formed in the second inclined surface 12 of the upper dial 1, making it difficult for the solar cell 70 to be seen from the outside. In other words, the opening portion 131 of the light transparent part 13 is provided in a position lower than an apex P of the first inclined surface 11. Specifically, as shown in FIG. 4, in a case that a height position of the apex P of the first inclined surface 11 in the thickness direction H is “a,” the opening portion 131 of the light transparent part 13 is at a height position “B” which is lower than “a,” even at the highest position in the thickness direction H. This makes it difficult to see the opening portion 131 in a case that the timepiece 100 is viewed from the 6 o'clock side. Therefore, the solar cell 70, which is located on the lower side (rear side) of the reference plane Rp of the dial, is not easily visible to a user wearing the timepiece 100.

Next, the action of the dial 10 and the timepiece 100 equipped with the dial 10 according to the present embodiment will be described. The dial 10 according to the present embodiment is formed by overlapping the upper dial 1 on top of the lower dial 2, which is made of a transparent or other resin material. The upper dial 1 is provided with the hour markers 16 and the date window 18 as appropriate. The cutout part 17 is formed in the portion where the sub-display 50 is located to match the position and shape of the small display plate 51. On the surface 1a of the upper dial 1, other than the portions where the hour markers 16, date window 18, etc. are provided, a plurality of valley shaped parts 110 consisting of the first inclined surface 11 and second inclined surface 12 are formed over almost the entire surface. According to the present embodiment, as shown in FIG. 1 to FIG. 3, the valley shaped part 110 is provided almost entirely in succession from the 6 o'clock side on one side of the timepiece to the 12 o'clock side on the other side of the timepiece. This creates a three-dimensional pattern of alternating peak portions and valley portions on the surface 1a of the upper dial 1.

Preferably, a length and inclination angle of the first inclined surface 11 and the length and inclination angle of the second inclined surface 12 are mostly constant. This aligns the shapes of the plurality of valley shaped parts 110 and the outer appearance has excellent design when the dial 10 is viewed. The length and inclination angle may be different between the first inclined surface 11 and the second inclined surface 12. For example, the first inclined surface 11 may ascend at a gradual angle and the second inclined surface 12 may descend at a steeper angle than the first inclined surface 11.

The light transparent part 13 which is the through hole is then formed at least partially between the adjacent first inclined surfaces 11. Specifically in the embodiment, the light transparent part 13 is formed to open toward a slope including the second inclined surface 12 that constitutes the valley shaped part 110. For example, in the example shown in FIG. 4, the light transparent part 13 is formed in the lower portion of the valley shaped part 110, and an opening portion 131 is provided from the middle of the second inclined surface 12 to a part of the first inclined surface 11 which constitutes the same valley shaped part 110. The opening portion 131 of the light transparent part 13 has a lower height position in the thickness direction H than the apex P of the first inclined surface 11. According to the present embodiment, as shown in FIG. 1 and FIG. 2, the opening portions 131 are slit-shaped, long in the 3 o'clock to 9 o'clock direction in the timepiece, and are arranged in multiple rows in the 3 o'clock to 9 o'clock direction in each valley shaped part 110. The opening portions 131 formed in each valley shaped part 110 are staggered entirely, for example, displaced in the 3 o'clock to 9 o'clock direction. This makes the dial 10 visible as a brick-like three-dimensional pattern when viewed from the outside.

The opening portion 131 is obscured from view by the first inclined surface 11 of the adjacent valley shaped part 110 in a case that the timepiece 100 is viewed from the 6 o'clock side, and the solar cell 70, which is located on a deeper side than the opening portion 131 (lower side in the thickness direction H), is also hidden and difficult to see from outside. Since the opening portion 131 is provided on the slope including the second inclined surface 12 that constitutes the valley shaped part 110, the appearance changes as the timepiece 100 is viewed from different viewing directions or angles, such as from the 3 o'clock side or the 9 o'clock side, or from the 12 o'clock side. This achieves the outer appearance with a highly stylish design. Furthermore, according to the present embodiment, the metal vapor deposition film such as aluminum is formed on the surface 1a of the dial 10 (upper dial 1). This produces a more three-dimensional and varied outer appearance depending on the direction and angle from which the user views the dial 10.

The upper dial 1 includes the vertical wall 132 formed from the opening portion 131 toward the solar cell 70 (reference plane Rp of the dial) side. The vertical wall 132 is provided at least on the side against the first inclined surface 11 and reflects the reflected light L2 reflected on the first inclined surface 11 toward the solar cell 70 (reference plane Rp of the dial) side. Furthermore, the vertical wall 132 also reflects the light L2 that enters the light transparent part 13 and is reflected on the inner surface toward the solar cell 70 (reference plane Rp of the dial) side. According to the present embodiment, the vertical wall 132 constitutes the inner surface of the light transparent part 13. According to the present embodiment, the vertical wall 132 is almost orthogonal to the solar cell 70 (the reference plane Rp of the dial). Therefore, when the metal vapor deposition film such as aluminum is formed on the surface 1a of the dial (upper dial 1) as described above, the metal vapor deposition film at the similar degree or near the similar degree as the first inclined surface 11 and the second inclined surface 12 is also formed on the vertical wall 132. This allows the vertical wall 132, together with the first inclined surface 11 and the second inclined surface 12, to better reflect the reflected light L2. With this, the light can enter the reference plane Rp of the dial and then to the solar cell 70 (light receiving surface of the solar cell 70) located on the rear side of the dial 10.

According to the present embodiment, the case in which the opening surface of the light transparent part 13 of the dial 10 located on one side of the light transparent part 13, which is the through hole (vertical wall 132 in this embodiment), is formed in a direction substantially orthogonal to the light receiving surface of the solar cell 70 is illustrated. However, the position and size of the light transparent part 13 and the angle of the vertical wall 132 are not limited to the illustrated example. However, the position and size of the light transparent part 13 and the angle of the vertical wall 132 are not limited to the illustrated example. For example, the vertical wall 132 need only be formed from the opening portion 131 in the second inclined surface 12 toward the light receiving surface of the solar cell 70 (reference plane Rp of the dial) and need not be orthogonal to the light receiving surface of the solar cell 70 (reference plane Rp of the dial). The opening surface of the light transparent part 13 (vertical wall 132 in this embodiment) may be formed, for example, to rise at an acute angle to the light receiving surface of the solar cell 70 (reference plane Rp of the dial). The vertical wall 132 may rise at a somewhat obtuse angle from the light receiving surface of the solar cell 70 (reference plane Rp of the dial). Even when the vertical wall 132 rises at an acute angle, the size (width) of the opening portion 131 should be large enough so as not to obstruct light L1 directly incident from the upper direction of the light transparent part 13.

As shown above, the upper dial 1 has a three-dimensional pattern. In other words, the upper dial 1 is provided with valley shaped parts 110, which are substantial valley shapes in the cross-sectional view, covering almost the entire surface. And, as mentioned above, the opening ratio of the opening portion 131 of the light transparent part 13 is about 17 to 20% of the total area in the dial 10 (in this embodiment, the upper dial 1). As a result, light transmission in the portion where the valley shaped part 110 which is the three-dimensional pattern is provided is limited to the portion from this opening portion 131, and this results in a low light transmission rate. It is said that the power generation efficiency of the solar cell 70 will be better if the solar cell 70 can receive light as evenly as possible throughout the entire surface. If the light transmission rate differs between the portion where the upper dial 1 with the three-dimensional pattern processed thereon overlaps and the portion where the portion does not overlap, the overall power generation efficiency of the solar cell 70 may be reduced. In this regard, in the lower dial 2 of the present embodiment, the portion of the dial that does not overlap with the upper dial 1, such as the portion corresponding to the cutout part 17 of the upper dial 1, is processed to reduce light transmission. In this way, the dial 10 is adjusted so that the overall light transmittance is approximately equally 20%, both in the portion with the cutout part 17 and the portion without the cutout part 17.

When the dial 10 with such configuration of the present embodiment is applied as the dial of the timepiece 100, the user can enjoy various views of the three-dimensional pattern on the upper dial 1 by rotating the wrist when the timepiece 100 is worn on the arm and changing the direction and angle of viewing the dial 10, causing the angle of the three-dimensional pattern to change. In a case that the timepiece 100 is worn on the arm and used as a wristwatch, the user will see the dial 10 from the 6 o'clock side. According to the present embodiment, the opening portion 131 of the light transparent part 13 is formed on the second inclined surface 12, which is a slope that is difficult to see from the 6 o'clock side. This makes the opening inconspicuous. Moreover, the solar cell 70 located deep in the opening is difficult to see from the outside, and the color of the solar cell 70 is not distracting. Furthermore, the overall pattern is almost uniformly repeated in a three-dimensional pattern, which is excellent in terms of outer appearance and design. Therefore, if the user turns his/her wrist, the through hole can be seen or not seen, making the product appear more three-dimensional, which is an excellent design feature.

In the solar cell 70 located on the rear side (lower side) of the dial 10, both the light L1 entering the light transparent part 13 directly from above and reflected light L2 reflected from the surrounding surfaces of the light transparent part 13, such as the first inclined surface 11, etc., enter the solar cell 70 through the light transparent part 13. Furthermore, if the transmittance of light that can be taken in from the light transparent part 13 (opening portion 131 of light transparent part 13) is about 20% of the total area in the portion where the three-dimensional pattern is provided, which occupies a large region in the upper dial 1, the light transmittance in the portion corresponding to the cutout part 17 and other portions where the upper dial 1 does not overlap will be high. Therefore, in this portion, the lower dial 2 is adjusted to reduce light transmittance by surface treatment or other means. This allows light to enter the solar cell 70 evenly entirely with a transmission rate of about 20%, thereby increasing the efficiency of power generation. Therefore, the timepiece 100 according to the present embodiment can improve the efficiency of light input to the solar cell 70 and also increase the power generation efficiency, while achieving a highly designable outer appearance. This allows the timepiece 100 to obtain sufficient power from the solar cell 70 to operate.

As described above, according to the present embodiment, the dial 10 provided on the timepiece 100 includes a plurality of first inclined surfaces 11 that are formed from one side to the other side, going up from one side toward the other side from the solar cell 70 side (reference plane Rp side of the dial 10). The light transparent part 13, which is the through hole, is formed at least partially between the adjacent first inclined surfaces 11, and the region of the dial 10 (decorative plate) located on one side of the light transparent part 13 and the region of the dial 10 (decorative plate) located on the other side of the light transparent part 13 are provided at positions that do not overlap in plan view.

Thus, the top of the light transparent part 13 is not blocked, allowing the light L1 to be taken in at least directly into the solar cell 70 through the light transparent part 13. In addition to the directly incident light L1, some of the reflected light L2 reflected from the surrounding surfaces of the light transparent part 13, such as the first inclined surface 11, can also be directed to the solar cell 70 (light receiving surface of the solar cell 70). This can improve the efficiency of the light L1 and the light L2 entering the solar cell 70. Furthermore, assuming normal use of the wristwatch 100 worn on the arm, when viewed from the 6 o'clock side, which is the viewing direction, the opening portion 131 is difficult to see, preventing the solar cell 70 located below (rear side) the dial 10 from being visible. On the other hand, when the timepiece 100 is viewed from the upper side in the thickness direction H, the opening portion 131 is visible, and the three-dimensional shape, such as a continuous brick-like three-dimensional pattern, allows the wearer to enjoy a luxurious outer appearance. Furthermore, since the dial 10 includes a three-dimensional shape, the appearance of the dial varies depending on the viewing direction, viewing angle, and the degree of light exposure, etc., giving it an excellent design outer appearance. When the user looks at the timepiece 100 from the 6 o'clock side, the three-dimensional effect is relatively less noticeable and the position of the hand 40 is easier to read.

In this embodiment, the opening portion 131 of the light transparent part 13 (through hole) is located lower than the apex P of the first inclined surface 11. Therefore, when the user wearing the timepiece 100 on his/her arm views at the dial 10 from the 6 o'clock side of the timepiece 100, etc., it is difficult to see the opening portion 131, the inside of the opening portion 131, etc.

Furthermore, the valley shaped part 110 of the present embodiment is formed in a substantial V-shape in the cross-sectional view, thus the V-shape is continuous and makes the dial 10 look more three-dimensional.

In this embodiment, the light transparent part 13 includes the vertical wall 132 formed from the opening portion 131 formed in the second inclined surface 12, etc. toward the reference plane Rp of the dial, and the vertical wall 132 reflects at least the reflected light L2 reflected on the first inclined surface 11 toward the reference plane Rp side of the dial 10. Therefore, the solar cell 70 receives not only the light L1 directly incident on the light transparent part 13 from above, but also the reflected light L2 reflected by the surrounding inclined surfaces, such as the second inclined surface 12. This allows the solar cell 70 to capture more light.

The metal vapor deposition film may be formed on the surface 1a of the dial 10. In this case, the light L2 can be reflected more efficiently on each surface on the dial 10, such as the first inclined surface 11. According to the present embodiment, the opening portion 131 is open toward the top of the dial 10, so the metal vapor deposition film can also be formed in the light transparent part 13 by vapor deposition. Therefore, the light L2 incident in the light transparent part 13 is efficiently reflected by the vertical wall 132, etc., and guided to the solar cell 70. Furthermore, the surface 1a of the dial 10 can be provided with the metal vapor deposition film to give it a metallic luster and a luxurious finish in terms of outer appearance design.

In a case that the timepiece 100 includes the dial 10 according to the present embodiment and the solar cell 70 located on the rear side of the dial 10, the outer appearance with a three-dimensional pattern provides a high level of design and a sense of luxury. The dial 10 has a structure that can guide both the directly incident light L1 and the reflected light L2 to the solar cell 70. This allows the solar cell 70 to generate more electricity. The dial 10 according to the present embodiment can also take in light L1 incident from a direction that is substantially orthogonal to the light receiving surface of the solar cell 70. The light L1 from a direction substantially orthogonal to the light receiving surface of the solar cell 70 is more efficient than external light incident at an angle to the light receiving surface of the solar cell 70. Therefore, this allows the solar cell 70 to generate electricity more efficiently.

Various embodiments of the present invention are described above but the present invention is not limited to the above embodiments, and various modifications are possible without leaving the scope of the present disclosure. For example, in the above embodiment, the case in which the dial 10 consists of two layers, the upper dial 1 and the lower dial 2, is illustrated. Alternatively, the dial 10 may consist of one layer, as long as it has a configuration at least equivalent to the upper dial 1 as described in the above embodiment. In this case, the face of the dial that is located on the solar cell 70 side is the reference plane of the dial.

In the above embodiment, the case in which a plurality of valley shaped parts 110 are provided successively is illustrated, but the plurality of valley shaped parts 110 need not be successive. For example, a flat portion or the like may be provided as appropriate between the valley shaped parts 110. According to the present embodiment, the through hole (light transparent part 13) formed in the upper dial 1 is an opening, but the inside of the through hole (light transparent part 13) need not necessarily be hollow. The through hole can be a light-permeable part that allows external light to enter the light receiving surface of the solar cell 70, and a visible light-transmitting material or the like may be placed inside the through hole.

According to the present embodiment, the case in which the apex of the portion forming a mountain shape in the cross-sectional view formed by the first inclined surface 11 of one valley shaped part 110 and the second inclined surface 12 of the adjacent valley shaped part 110 is pointed is illustrated. The apexes of the mountain portions in the cross-sectional view may not be pointed and may be gently arc-shaped. The first inclined surface 11 and the second inclined surface 12 are not limited to those that are strictly straight in lateral view. The first inclined surface 11 and the second inclined surface 12 may include curved portions, such as corrugated surfaces.

The dial 10 (upper dial 1) of the above embodiment includes the second inclined surface 12 that descends from one side to the other side toward the solar cell 70 side, and the first inclined surface 11 and the second inclined surface 12 constitute the valley shaped part 110 that is valley shaped in the cross-sectional view. However, the three-dimensional pattern on the dial 10, which is the decorative plate, is not limited to one that constitutes a valley shape in the cross-sectional view with the first inclined surface 11 and the second inclined surface 12. The three-dimensional pattern on the dial 10, which is the decorative plate, may, for example, have only the first inclined surface 11 that goes up from one side to the other side from the solar cell 70 side.

The dial 10 (upper dial 1) of the above embodiment includes the opening portion 131 formed in the second inclined surface 12 that descends from one side to the other side toward the solar cell 70. However, the arrangement of the opening portions 131, etc., is not limited to this configuration. For example, if the upper dial 1 includes only the first inclined surface 11 and not the second inclined surface 12 as described above, the vertical wall 132 may be formed from the apex P of the first inclined surface 11 toward the solar cell 70 side. In this configuration, the reflected light L2 is also repeatedly reflected between the vertical walls between the adjacent first inclined surfaces 11, leading the light to the solar cell 70. Therefore, the same effect can be obtained as when the first inclined surface 11 and the second inclined surface 12 are formed on the upper dial 1.

According to the above embodiment, the case in which the metal vapor deposition film is formed on the surface 1a of the dial 10 (upper dial 1 in the dial 10) is illustrated, but it is not essential that the metal vapor deposition film is formed. For example, if the dial 10 is formed of a brightly colored material such as white, it can reflect light sufficiently even without the metal vapor deposition film. In this case, the metal vapor deposition film is not required.

According to the above embodiment, the timepiece 100 includes the plurality of hands 40 attached to the pointer shaft 41 provided approximately in the center of the dial 10 as the decorative plate, and displays time in an analog manner. However, the timepiece configuration is not limited to this. The dial 10 (decorative plate) under the hands 40 may not be provided on the entire surface, but on a portion such as the 6 o'clock side, and the face on the viewing side of the timepiece may have a digital display consisting of a liquid crystal panel or the like, in addition to the dial 10. In this case, the timepiece is a so-called combination timepiece that includes an analog display and a digital display. Alternatively, the digital timepiece provided with only the digital display rather than the analog type such as hands, and provided with the decorative plate according to the present embodiment around the periphery of the digital display, can also be applied. In either case, the through hole which is to be the light transparent part, is formed in the region of the decorative plate.

In each of the above embodiments, the case in which the dial 10 is the dial of the timepiece (wristwatch) 100 is illustrated, but the devices to which the dial of the present invention can be applied are not limited to timepieces. The dial may be widely applied to devices with components such as the solar cell 70 that generates electricity from the light incident through the dial. For example, the dial can also be widely applied to various electronic devices such as smart watches and sports watches, as well as wearable devices that acquire information in addition to time, for example, biological information such as heart rate and blood flow information.

Although several embodiments of the invention have been described above, the scope of the invention is not limited to the embodiments described above, and the specific configuration, structure, and positional relationship shown in the above embodiments can be changed as needed without departing from the scope of the invention. The invention also includes the scope of the claims and their equivalents.

What is claimed is:

1. A decorative plate placed on one surface side of a solar cell, the decorative plate comprising:
a plurality of first inclined surfaces formed from one side to an other side, wherein the first inclined surfaces rise from the solar cell side, and the first inclined surfaces rise from the one side to the other side; and
a through hole formed in at least a part between adjacent first inclined surfaces,
wherein a region of the decorative plate located on the one side of the through hole and a region of the decorative plate located on the other side of the through hole are provided in positions that do not overlap in plan view.

2. The decorative plate according to claim 1, wherein an opening surface of the through hole in the decorative plate located on the one side of the through hole is formed in a direction substantially orthogonal to a light receiving surface of the solar cell or at an acute angle to a light receiving surface of the solar cell.

3. The decorative plate according to claim 1,
further comprising a second inclined surface,
wherein,
the second inclined surface is formed to descend from the one side to the other side toward the solar cell side, and
the first inclined surface and the second inclined surface form a valley shape in the cross-sectional view.

4. The decorative plate according to claim 2,
further comprising a second inclined surface,
wherein,
the second inclined surface is formed to descend from the one side to the other side toward the solar cell side, and
the first inclined surface and the second inclined surface form a valley shape in the cross-sectional view.

5. The decorative plate according to claim 1, wherein the one side is a thumb side when a timepiece is worn on an arm, and the other side is a little finger side when the timepiece is worn on the arm.

6. The decorative plate according to claim 2, wherein the one side is a thumb side when a timepiece is worn on an arm, and the other side is a little finger side when the timepiece is worn on the arm.

7. The decorative plate according to claim 3, wherein the one side is a thumb side when a timepiece is worn on an arm, and the other side is a little finger side when the timepiece is worn on the arm.

8. The decorative plate according to claim 4, wherein the one side is a thumb side when a timepiece is worn on an arm, and the other side is a little finger side when the timepiece is worn on the arm.

9. The decorative plate according to claim 3, wherein an opening surface of the through hole is formed in a position lower than an apex of the second inclined surface.

10. The decorative plate according to claim 4, wherein an opening surface of the through hole is formed in a position lower than an apex of the second inclined surface.

11. The decorative plate according to claim 3, wherein the valley shape in the cross-sectional view is a substantial V-shape in the cross-sectional view.

12. The decorative plate according to claim 4, wherein the valley shape in the cross-sectional view is a substantial V-shape in the cross-sectional view.

13. The decorative plate according to claim 3, wherein the plurality of through holes are formed in the decorative plate in a slit-shape long in a longitudinal direction of an arm when a timepiece is worn on the arm, and are arranged to be the valley shape in the cross-sectional view.

14. The decorative plate according to claim 4, wherein the plurality of through holes are formed in the decorative plate in a slit-shape long in a longitudinal direction of an arm when a timepiece is worn on the arm, and are arranged to be the valley shape in the cross-sectional view.

15. The decorative plate according to claim 13, wherein the plurality of through holes are arranged in a staggered pattern.

16. The decorative plate according to claim 14, wherein the plurality of through holes are arranged in a staggered pattern.

17. The decorative plate according to claim 1, wherein a metal vapor deposition film is formed on a surface.

18. The decorative plate according to claim 2, wherein a metal vapor deposition film is formed on a surface.

19. A timepiece comprising:
the decorative plate according to claim 1, and
a solar cell.

20. A timepiece comprising:
the decorative plate according to claim 2, and
a solar cell.
